(19) United States
(12) Patent Application Publication
(10) Pub. No.: US 2014/0263259 A1
(43) Pub. Date: Sep. 18, 2014

(54) CONSUMABLE FOR SPECIALLY COATED METALS

(71) Applicant: LINCOLN GLOBAL, INC., City of Industry, CA (US)

(72) Inventor: Badri K. NARAYANAN, Mayfield Heights, OH (US)

(73) Assignee: LINCOLN GLOBAL, INC., City of Industry, CA (US)

(21) Appl. No.: 13/798,398

(22) Filed: Mar. 13, 2013

(51) Int. Cl. B23K 35/362

(52) U.S. Cl. CPC B23K 35/362
USPC 219/145.22

(57) ABSTRACT

A consumable electrode for use in arc welding applications, e.g., gas shielded metal arc welding (GMAW) or gas shielded flux core arc welding (FCAW-G) applications, on a workpiece with a metal coating, e.g., zinc. The electrode includes a metal sheath surrounding a core, and filler materials are disposed in the core. The filler materials include fluxing materials that facilitate a partitioning of the coating of the workpiece into a slag formed at least in part by the fluxing materials. The fluxing materials include deoxidizing materials in a range of 2% to 6% by weight of the electrode. The deoxidizing materials can include aluminum and/or magnesium. To reduce fume formation, the concentration of the slag forming materials in the core is limited to that needed to partition enough zinc away from the weld/slag interface to produce a weld with little or no porosity.

### TECHNICAL FIELD

Certain embodiments relate to consumable electrodes used in arc welding applications. More particularly, certain embodiments relate to porosity resistant, low fume consumable electrodes used in gas shielded metal arc welding (GMAW) or gas shielded flux core arc welding (FCAW-G) applications on a workpiece with a metal coating.

### BACKGROUND

Metals such as iron or steel may be galvanized, e.g., coated with zinc. The zinc coatings prevent corrosion of the underlying iron or steel by forming a physical barrier. In addition, the zinc can act as a sacrificial anode to protect the iron or steel even when the barrier is scratched or damaged. Galvanized steel can be welded but the zinc coating creates numerous problems. In addition to the zinc oxide fume being generated, the zinc coating may produce volatiles and oxides that can adversely affect weld quality. For example, zinc vapor can get trapped in the weld puddle, which can then lead to high porosity in the finished weld. This happens when the weld puddle cools before the vapor can escape, when there is no escape route for the vapor, and/or when there is a high concentration of zinc volatiles. In addition, the zinc volatiles and zinc oxide can interfere with the arc and generate high spatter, resulting in an unsound weld. Because of these problems, the galvanized workpiece is routinely prepped by removing the zinc coating, e.g., by grinding, prior to the main welding operation. However, prepping the workpiece prior to welding is time consuming and inefficient. Thus, the trend is to weld over the coating rather than removing the coating first. However, this method results in welds with significant spatter that causes issues when the workpiece is later painted and/or can cause internal porosity that results in poor mechanical properties (fatigue life)

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a consumable electrode for use in arc welding, such as gas shielded arc welding (GMAW) or gas shielded flux core arc welding (FCAW-G) applications on a workpiece with a metal coating, e.g., a zinc coating. Such applications can include any of brazing, cladding, building up, filling, hard-facing overlaying, joining, and welding applications. The electrode includes a metal sheath surrounding a core, and filler materials are disposed in the core. The filler materials can include iron, e.g., in a range of 8% to 12% by weight of the electrode. Of course, in addition to the iron in the filler materials, the metal sheath can also include iron. For example, the metal sheath can be 100% iron. The filler materials further include fluxing materials that facilitate a partitioning of the coating of the workpiece into a slag formed at least in part by the fluxing materials. The fluxing materials include deoxidizing materials in a range of 2% to 6% by weight of the electrode. The deoxidizing materials can include aluminum and/or magnesium. To reduce fume formation, the concentration of the slag forming materials in the core is limited to that needed to partition enough of the coating metal away from the weld/slag interface to produce a weld with little or no porosity.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary system for GMAW or FCAW-G applications that is consistent with the present invention;

FIG. 2 illustrates an exemplary embodiment of a consumable electrode that can be used in the system of FIG. 1; and

FIG. 3 illustrates an instructive cross-sectional view of a weld/slag interface produced by the system of FIG. 1 using the consumable of FIG. 2.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

FIG. 1 illustrates a functional schematic block diagram of an exemplary system for GMAW or FCAW-G applications. While the present invention is described in terms of a consumable for use in GMAW/FCAW-G applications, the present invention can also be used in other types of processes. The system includes a welding power supply 80. The power supply 80 is a pulsed direct current (DC) power supply, although alternating current (AC) or other types of power supplies are possible as well. The configuration of power supply 80 is well-known in the art and, for brevity, will not be further discussed.

The power supply 80 is operatively connected to contact tube 20, which is housed in torch 10. The contact tube 20 makes contact with consumable electrode 40. The power supply 80 can include an arc initiation circuit (not shown) to create an arc 30 between the consumable electrode 40 and workpiece 50. Once the arc 30 is formed, the power supply 80 provides a current via contact tube 20, consumable electrode 40, and the arc 30 to heat the workpiece 50 and form weld puddle 45. During operation, the arc 30 melts the consumable electrode 40, which provides filler material for joining, welding, brazing, cladding, etc. A wire feed system 90 feeds the consumable electrode 40 toward the workpiece 50 as the electrode 40 is being consumed. The workpiece 50 also has a zinc coating 52 that is melted or vaporized by the arc 30 during the heating process. To help reduce porosity in the finished weld layer due to atmospheric nitrogen and oxygen, gas supply 60 provides shielding gas 70 to torch 10. The shielding gas 70 displaces the atmosphere and forms a shield around the arc 30 and the weld puddle 45. As discussed further below, the interactions of the filler materials in the consumable electrode 40 with the coating 52 and the workpiece 50 during the welding process produces a weld/slag layer 54.

As discussed above, the zinc coating 52 is problematic in that it produces porosity in the finished weld. To address this problem, the present invention, as illustrated in FIG. 2, provides a porosity resistant, low fume consumable electrode 100 that is designed for coated metals, e.g., zinc-galvanized steel. In an exemplary embodiment of the present invention, the consumable electrode 100 can be a cored filler wire with a steel sheath 110. The sheath 110 surrounds a core 120 having iron powder 130, fluxing materials 140, and alloying agents 150. In some exemplary embodiments, the consumable electrode 100 can be a flux-cored filler wire. In other exemplary embodiments, the electrode 100 is a metal cored filler wire. In exemplary embodiments of the present invention, the electrode 100 may be specifically designed to be used with shielding gas when welding. In still other embodiments, the consumable electrode 100 is designed to be used in a direct current electrode negative (DCEN) configuration.

In exemplary embodiments of the present invention, the sheath 110 can be made of low carbon steel with 0.05% to 0.1% carbon by weight of the sheath 110. With respect to the filler materials in the core 120, the main component of the core is iron 130. The fill percent of the iron 130 in the core 120 is in the range of 49% to 80% by weight of the core 120. The core also contains fluxing materials 140. As discussed further below, the fluxing materials 140 are included to at least produce slag, which facilitates the removal of zinc and/or helps prevent nitrogen from entering the weld puddle. The fluxing materials 140 can include metal fluorides (or acidic oxides) and deoxidizing metals. In some exemplary embodiments of the present invention, the fluorides can be, for example, barium fluoride, calcium fluoride, and/or strontium fluoride. Of course, the present invention is not limited to just these fluorides and can include other fluorides so long as they promote the formation of slag. In some embodiments, the deoxidizing materials can be magnesium and/or aluminum. Again, the present invention is not limited to these deoxidizers and can include other deoxidizing metals so long as they promote the partitioning of the zinc in the slag as discussed below. Based on the welding process and the desired weld characteristics, the electrode 100 may also contain alloying agents 150 such as carbon, manganese, silicon, titanium, chrome, nickel, boron, molybdenum, zirconium, calcium, and/or barium. Of course, the alloying agents 150 are not limited to the above elements and compounds and can include other alloying agents based on the desired weld characteristics.

As discussed above, an important concern when welding zinc-galvanized metals is the porosity due to the trapped zinc vapors. However, the porosity can also be caused by atmospheric nitrogen being trapped in the weld puddle as the filler wire is transferred to the weld puddle. In this regard, the metal fluorides (or acidic oxides) and deoxidizing metals discussed above can help prevent the atmospheric nitrogen and oxygen from making contact with the weld puddle. During the welding process, the fluorides and deoxidizers are released from the consumable electrode 100 to help form the slag. The slag is rich in oxides and will form as the aluminum, magnesium, and other materials react with the oxygen in the atmosphere. The slag cools and solidifies before the weld puddle and floats on top of the weld puddle. The slag then acts as a barrier that helps prevent atmospheric nitrogen and oxygen from entering the weld puddle 45.

Moreover, in the present invention, the slag also helps in removing the zinc volatiles and zinc oxides, which are formed during the welding process, from the weld puddle 45. As illustrated in FIG. 3, when welding zinc-galvanized steel, a two-phase slag layer 310/320 forms on top of weld layer 300. At the weld/slag interface 305, the aluminum and/or magnesium oxides form a relatively dense slag layer 310. A second slag layer 320 that is less dense and mostly made of zinc oxide forms on top of the dense slag layer 310. That is, the zinc is partitioned away from the weld/slag interface 305 into a more porous section of the slag. The partitioning of the zinc is analogous to a desulphurization process in steel making. In that process, the fluxing additions increase the sulfur capacity of the slag, thus decreasing the sulfur trapped in the steel. Similarly, by partitioning the zinc away from the weld/slag interface 305 with the use of aluminum and magnesium, less zinc is trapped in the weld puddle 45. In this case, the weld/slag interface 305 will predominantly be an oxide rich in aluminum and/or magnesium.

While the slag has beneficial effects in acting as a barrier against atmospheric nitrogen and oxygen and in partitioning the zinc away from the weld, some of the fluorides, oxidizers, and oxides used to produce the slag form fumes. For example, fluorides such as calcium fluoride, barium fluoride, and strontium fluoride and deoxidizers such as magnesium produce significant slag and generate fumes. In addition, because the slag must be removed from the finished weld, too much slag makes the fabrication process inefficient. Accordingly, in the exemplary embodiments of the present invention, to reduce fume and slag formation, the concentration of the slag forming materials in the core 120 is limited to that needed to partition enough of the zinc away from the weld/slag interface 305 to produce a weld 300 with little or no porosity. Such welds can achieve tensile strengths in a range of 450 MPa to 900 Mpa. In exemplary embodiments of the present invention, the fluorides in consumable electrode 100 can be in the range of 0% to 2.2% by weight of the electrode 100. In some embodiments, the fluorides are in the range of 0.43% to 0.52% by weight of the electrode 100. In exemplary embodiments of the present invention, the deoxidizers can be in the range of 2% and 6% by weight of the electrode 100, and in some embodiments, the deoxidizers are in the range of 4.15% to 5.03% by weight of the electrode 100. Additionally, in exemplary embodiments of the invention, the carbon in the filler material can be in the range of 0% to 0.5% by weight of the electrode 100, and in some embodiments the carbon is at about 0.003% by weight of the electrode 100. In some exemplary embodiments, the consumable electrode 100 can have fill materials as shown in Table 1.

TABLE 1
Percent Range of Fill Materials

| | Min % | Max % | Min % Fill | Max % fill |
|---|---|---|---|---|
| | Wire | Wire | (15.5% fill) | (15.5% fill) |
| Al | 2 | 5 | 12.90 | 32.26 |
| Ba | 0 | 0.1 | 0.00 | 0.65 |
| C | 0 | 0.5 | 0.00 | 3.23 |
| Ca | 0 | 0.1 | 0.00 | 0.65 |
| Fe | 8 | 12 | 51.61 | 77.42 |
| Mg | 0 | 1 | 0.00 | 6.45 |
| Mn | 0 | 1.2 | 0.00 | 7.74 |
| Si | 0.1 | 0.3 | 0.65 | 1.94 |
| Ti | 0 | 0.03 | 0.00 | 0.19 |
| Al₂O₂ | 0 | 0.04 | 0.00 | 0.26 |
| SiO₂ | 0 | 0.01 | 0.00 | 0.06 |
| BaF₂ | 0 | 1.5 | 0.00 | 9.68 |
| SrF₂ | 0 | 0.04 | 0.00 | 0.26 |
| CaF2 | 0 | 0.3 | 0.00 | 1.94 |

The first column of Table 1 has an exemplary list of fill materials that can be used in electrodes that are consistent with the present invention. Of course, other materials can be used without departing from the spirit of the invention. The next two columns show the minimum and maximum percentage by weight of the wire (electrode) of each of the fill materials. As indicated by the 0% in the Min % column, not all the listed materials are necessarily present in every embodiment of the present invention. However, in some exemplary embodiments of the invention, the combination of the fill materials makes up approximately 15.5% by weight of the electrode 100. In the exemplary embodiments disclosed in Table 1, the last two columns show the minimum and maximum percentage of each fill material as a percentage by weight of the total fill material.

Table 2 shows the chemistry of an exemplary embodiment of the electrode 100. The “Fill” column shows the percentage by weight of the total fill material with the fill materials making up about 15.5% by weight of the electrode 100. The next two columns show a variance (i.e., the minimum percentage and the maximum percentage) as percent by weight of the wire (electrode) of each fill material in exemplary embodiments of the invention. Thus, the percentage of fill materials in these embodiments can range from about 14% to about 17%

TABLE 2

| Breakdown | Fill | Min % | Max % |
|---|---|---|---|
| Chemistry | (15.5%) | Wire | Wire |
| Al | 26.98 | 3.78 | 4.59 |
| Ba | 0.32 | 0.04 | 0.05 |
| C | 0.02 | 0.003 | 0.003 |
| Ca | 0.36 | 0.05 | 0.06 |
| Fe | 64.97 | 9.09 | 11.04 |
| Mg | 2.61 | 0.37 | 0.44 |
| Mn | 0.15 | 0.02 | 0.03 |
| Si | 1.33 | 0.19 | 0.23 |
| Ti | 0.01 | 0.002 | 0.002 |
| Al₂O₂ | 0.12 | 0.02 | 0.02 |
| SiO₂ | 0.07 | 0.01 | 0.01 |
| BaF₂ | 2.92 | 0.41 | 0.5 |
| SrF₂ | 0.08 | 0.01 | 0.01 |

In exemplary embodiments of the present invention, the consumable electrode 100 may be used in a GMAW system or a FCAW-G system such as that illustrated in FIG. 1. The classification of whether electrode 100 is metal cored electrode or a flux cored electrode will depend on the amount of flux material 140 in the core 120.

In the above embodiments, the electrode 100 is designed for reduced slag formation. Therefore, in some applications, there can be a greater risk of atmospheric nitrogen being transferred to the weld puddle 45 and thus porosity of the weld bead. Accordingly, consistent with the present invention, the consumable electrode 100 may be designed to be used with shielding gas 70 as shown in FIG. 1 to provide additional porosity protection. The shielding gas 70 displaces the atmospheric nitrogen and oxygen around the arc 30 and weld puddle 45 by forming an envelope around them. The shielding gas 70 can be argon, helium, carbon dioxide, or any other inert gas or any blend thereof. For example, the shielding gas 70 may be a combination of carbon dioxide and argon in which the concentration of carbon dioxide in the argon ranges from 10% to 25%.

In some exemplary embodiments, the GMAW or FCAW-G system can be set up as direct current electrode negative (DCEN). In the direct current electrode positive (DCEP) mode, there is high penetration of the workpiece producing a “keyhole effect.” Thus, there can be increased interaction with the zinc coating in the root of the weld using the DCEP method. By using the DCEN method, there is minimal penetration, i.e., no keyhole effect, but the weld strength is not compromised. Because there is no keyhole effect, there is decreased interaction with the zinc coating and less risk of porosity.

By limiting the slag and fumes as discussed above, exemplary embodiments of the invention are capable of producing sound welds on galvanized metal at high travel speeds, e.g., 40 in/minute or higher. In addition, welds formed with a consumable electrode that is consistent with the present invention can achieve a tensile strength of greater than 700 M Pa, which matches high strength automotive sheet metal.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

We claim:

1. A consumable electrode for use in arc welding applications involving a workpiece with a zinc coating, said electrode comprising:
a metal sheath surrounding a core; and
filler materials disposed in said core, said filler materials comprising fluxing materials,
wherein said fluxing materials facilitate a partitioning of said zinc coating of said workpiece into a slag formed at least in part by said fluxing materials, and
wherein said fluxing materials comprise deoxidizing materials in a range of 2% to 6% by weight of said electrode.

2. The consumable electrode of claim 1, wherein said filler materials further comprise, by weight of said electrode, fluorides of not more than 2.2%, carbon of not more than 0.5%, and barium of not more than 0.1%.

3. The consumable electrode of claim 2, wherein said deoxidizing materials comprise, by weight of said electrode, aluminum in a range of 2% to 5% and magnesium of not more than 1%.

4. The consumable electrode of claim 3, wherein said fluorides comprise, by weight of said electrode, barium fluoride of not more than 1.5% and strontium fluoride of not more than 0.04%.

5. The consumable electrode of claim 4, wherein said filler materials further comprise, by weight of said electrode, calcium up to 0.5%, manganese up to 1.2%, silicon in a range of 0.1% to 0.3%, titanium up to 0.03%, aluminum oxide up to 0.04%, and silicon oxide up to about 0.01%.

6. The consumable electrode of claim 5, wherein said range of said aluminum is 3.78% to 4.59%, said magnesium is in a range of 0.37% to 0.44%, said barium is in a range of 0.04% to 0.05%, said carbon is 0.003%, said calcium is in a range of 0.05% to 0.06%, said manganese is in a range of 0.02% to 0.03%, said range of said silicon is 0.19% to 0.23%, said titanium is 0.002%, said aluminum oxide is 0.02%, and said silicon oxide is 0.01%.

7. The consumable electrode of claim 3, wherein said fluorides comprise, by weight of said electrode, barium fluoride of not more than 1.5% and calcium fluoride of not more than 0.3%.

8. The consumable electrode of claim 6, wherein said filler materials further comprise iron, and
wherein said filler materials range from 14% to 17% by weight of said electrode.

9. The consumable electrode of claim 8, wherein said consumable is designed for use in gas shielded applications.

10. A system for use in arc welding applications involving a workpiece with a zinc coating, said electrode comprising:
a welding power supply operatively connected to a consumable electrode to create an arc between said consumable electrode and said workpiece; and
a wire feeder system that feeds said consumable electrode to said workpiece;
wherein said consumable electrode comprises,
a metal sheath surrounding a core; and
filler materials disposed in said core, said filler materials fluxing materials,
wherein said filler materials facilitate a partitioning of said zinc coating of said workpiece into a slag formed at least in part by said fluxing materials, and
wherein said fluxing materials comprise deoxidizing materials in a range of 2% to 6% by weight of said electrode.

11. The system of claim 10, wherein said filler materials further comprise, by weight of said electrode, fluorides of not more than 2.2%, carbon of not more than 0.5%, and barium of not more than 0.1%, and
wherein said deoxidizing materials comprise, by weight of said electrode, aluminum in a range of 2% to 5% and magnesium of not more than 1%.

12. The system of claim 11, wherein said fluorides comprise, by weight of said electrode, barium fluoride of not more than 1.5% and strontium fluoride of not more than 0.04%, and
wherein said filler materials further comprise, by weight of said electrode, calcium up to 0.5%, manganese up to 1.2%, silicon in a range of 0.1% to 0.3%, titanium up to 0.03%, aluminum oxide up to 0.04%, and silicon oxide up to 0.01%.

13. The system of claim 12, wherein said range of said iron is 9.09% to 11.04%, said range of said aluminum is 3.78% to 4.59%, said magnesium is in a range of 0.37% to 0.44%, said barium is in a range of 0.04% to 0.05%, said carbon is 0.003%, said calcium is in a range of 0.05% to 0.06%, said manganese is in a range of 0.02% to 0.03%, said range of said silicon is 0.19% to 0.23%, said titanium is 0.002%, said aluminum oxide is 0.02%, and said silicon oxide is 0.01%,
wherein said filler materials further comprise iron, and
wherein said filler materials range from 14% to 17% by weight of said electrode.

14. The system of claim 11, wherein said fluorides comprise, by weight of said electrode, barium fluoride of not more than 1.5% and calcium fluoride of not more than 0.3%.

15. The system of claim 13, further comprising:
a shielding gas system that provides shielding gas to said electrode and said arc,
wherein said power supply is set up for a direct current electrode negative configuration.

16. A method of arc welding in applications involving a workpiece with a zinc coating, said method comprising:
creating an arc between a consumable electrode and said workpiece; and
feeding said consumable electrode to said workpiece;
wherein said consumable electrode comprises,
a metal sheath surrounding a core; and
filler materials disposed in said core, said filler materials comprising fluxing materials,
wherein said fluxing materials facilitate a partitioning of said zinc coating of said workpiece into a slag formed at least in part by said fluxing materials, and
wherein said fluxing materials comprise deoxidizing materials in a range of 2% to 6% by weight of said electrode.

17. The method of claim 16, wherein said filler materials further comprise, by weight of said electrode, fluorides of not more than 2.2%, carbon of not more than 0.5%, and barium of not more than 0.1%, and
wherein said deoxidizing materials comprise, by weight of said electrode, aluminum in a range of 2% to 5% and magnesium of not more than 1%.

18. The method of claim 17, wherein said fluorides comprise, by weight of said electrode, barium fluoride of not more than 1.5% and strontium fluoride of not more than 0.04%, and
wherein said filler materials further comprise, by weight of said electrode, calcium up to 0.5%, manganese up to 1.2%, silicon in a range of 0.1% to 0.3%, titanium up to 0.03%, aluminum oxide up to 0.04%, and silicon oxide up to 0.01%.

19. The method of claim 18, wherein said range of said iron is 9.09% to 11.04%, said range of said aluminum is 3.78% to 4.59%, said magnesium is in a range of 0.37% to 0.44%, said barium is in a range of 0.04% to 0.05%, said carbon is 0.003%, said calcium is in a range of 0.05% to 0.06%, said manganese is in a range of 0.02% to 0.03%, said range of said silicon is 0.19% to 0.23%, said titanium is 0.002%, said aluminum oxide is 0.02%, and said silicon oxide is 0.01%,
wherein said filler materials further comprise iron, and
wherein said filler materials range from 14% to 17% by weight of said electrode.

20. The system of claim 16, wherein said fluorides comprise, by weight of said electrode, barium fluoride of not more than 1.5% and calcium fluoride of not more than 0.3%.
